(19) United States
(12) Patent Application Publication
(10) Pub. No.: US 2005/0010717 A1
(43) Pub. Date: Jan. 13, 2005

(54) Access and data management method using double parallel tracks for flash memory cells

(76) Inventors: Soo-Ching Ng, Hsinchu Hsien (TW); Wee-Kuan Gan, Hsinchu Hsien (TW)

Correspondence Address: BIRCH STEWART KOLASCH & BIRCH, PO BOX 747, FALLS CHURCH, VA, 22040-0747, US

(21) Appl. No.: 10/612,961

(22) Filed: Jul. 7, 2003

(51) Int. Cl. G06F 12/00

(52) U.S. Cl. 711/103; 711/157; 711/5

(57) ABSTRACT

An access and data management method using parallel tracks comprising a plurality of flash memory cells, a plurality of independent USB ports for transferring sets of data from and within said flash memory cells, wherein when a target set of data is a plurality of sectors, then a controller uses a plurality of pages as a single unit to process reading and writing so that a plurality of pages can be read and written into the flash memory cells simultaneously each time. Further the parallel tracks of flash memory cells may be combined with an interleaving method, a mother and child conceptual structure and a copy back method for further enhancing the data processing speed and also extending the life of the flash memory cells.

### BACKGROUND OF THE INVENTION

1. The Field of the Invention

The present invention relates to an access and data management method for using double parallel tracks, and more particularly, relates to an access and data management method using double parallel tracks together with an interleaving management method to enable the controller to simultaneously transfer multiple sets of data into a plurality of flash memory cells. In other words, the present invention proposes to use parallel tracks to implement simultaneous access multiple sectors of the flash memory cells and transfer multiple sets of data into a plurality of flash memory cells, and use the interleaving method save the waiting time for completing the prior reading/writing actions, thereby exponentially increasing the access and data processing speed by and increasing the working life of the flash memory cell.

2. Description of the Related Art

The currently available information processor comprises a host with the prompt data processing transmission speed, the speed, for example, of a USB2.0 port is 480 mbs, IEEE1394 is 800 mbs, and the IDE interface is 16.66 mbs.

Flash memory cell is a non-volatile solid state memory that maintains data even after all power sources have been disconnected. Flash memory cell has been widely used in personal computers and other electronic equipment because of its programmable features allowing writing, erasing and reading data a number of times. When a read/write operation is to be performed on a certain sector of the active window of a flash memory cell, it would involve many stages of operations. If there are two sectors to be accessed, the conventional method is to execute the read/write operation on the first sector until all the stages are completed and then proceed to the read/write operation on the next sector. This sequential access method is undoubtedly low in efficiency. Accordingly, a substantial amount of time is required for read/write operations.

To write/erase the data in the flash memory cell, a bias voltage is applied to the drain in order to push electrons into the floating gate or pull electrons out of the floating gate by Fowler-Nordhem tunneling. To read the data in the flash memory cell, a working voltage is applied to the control gate to determine whether the channel is on or off (“1” or “0”). The value of the data (“0” or “1”) depends on the amounts of electrons trapped in the floating gate, which affect the status of the channel. For example, when the flash memory cell executes the erase step, the value of the data of the corresponding block will be 1, and when the flash memory cell executes the write step, the value of the data will be changed from 1 to 0 but however the value of the data cannot be changed from 0 to 1. During the erase step, a whole block is selected as a unit, therefore the controller selects the whole block as a unit. During file management operation, the controller often continuously renew the file arrangement table (FAT) of the flash memory cell, when the data to be written are all for small files and the flash memory cell can only process data of few blocks, then the flash memory cell needs to keep on finding new blocks for transferring the data from the old block to the new one and erase the data in the old one. Because of the physical characteristics of the flash memory cell, the programmable feature of the flash memory allows reading, writing and erasing for about one million times. Therefore, to extend the life of the flash memory cell is obviously to reduce the number of erasing processes.

For increasing the operation speed, the flash memory cell has a new command so called “Copy Back”, because the data stored in the flash memory cell needs to be transferred often, thus the actions of read and write are constantly required, and therefore the flash memory cell will be busy operating all the time. The command “Copy Back” commands the flash memory cell to hold the data in the buffer instead of reading out, and next a command “Copy Back Write”, allows the data that is temporarily stored in the internal buffer to be written into the flash memory cell, and the time to accomplish this action is substantially shorter compared to the conventional reading and writing process.

Referring to FIG. 1A, illustrates a conventional controller is ready for writing two sets of data from page 3 of block 0.

Referring to FIG. 1B, the conventional controller processes the first set of data, in a manner that the above data page 3 is processed first, and then this data is transferred from the corresponding page from the old block to the new block.

Referring to FIG. 1C, the conventional controller writes the data into page 3, which is to be written into the corresponding page in a new block.

Referring to FIG. 1D, the conventional controller writes the data into page 4 of a new block, however the controller will not immediately transfer the rest of pages of the old block to the new block, instead the controller continues to write data into the next page.

Referring to FIG. 1E, the conventional controller transfers the block below page 4 from the old block to the new one, after finishing writing all the data then transfers the rest of the blocks completely from the old block to the new one.

Additionally, referring to FIG. 1F, the conventional controller erases the old block and allows the new block replace the old block 0 and erases the old block.

The flash memory used in a manner described above will certainly increase the chance for the flash memory cell to break down. Therefore, it is highly desirable improve the file management with the view of reducing the number of erasing steps so that the life of the flash memory cell is not only prolonged but also this would significantly increase the operation speed of the flash memory cell.

However, the conventional Copy Back command has a drawback because the flash memory cell that recognize this command must have four different planes, and the Copy Back command is accepted only in the planes. These planes are located in a sequence of the block, for example, Plane 0 comprises Block 0, 4, 8 . . . , 1020 of all the zones, in other words, Plane 0 comprises all the blocks of the physical feature address of 4n+0 (0≦n≦255); and Plane 1 comprises block 1, 5, 9 . . . , 1021 of all the zones, in other words, Plane 1 comprises all the blocks of the physical feature address of 4n+1 (0≦n≦255), Plane 2 comprises block 2, 6, 10 . . . , 1022 of all the zones, in other words, Plane 2 comprises all the blocks of the physical feature address of 4n+2 (0≦n≦255), Plane 3 comprises block 3, 7, 11 . . . , 1023 of all the zones, in other words, Plane 3 comprises all the blocks of the physical feature address of 4n+3 (0≦n≦255). Thus the arrangement and file management of blocks are different from the conventional file management, in the, the zone 0 of the present invention is different from the actual block containing in zone 0 of the flash memory cell, and the blocks contained in zone 0 are block 4n+0 (0, 4, 8, . . . , 1020) of the actual zone 0, zone 1, zone 2 and zone 3 of the flash memory cell.

### SUMMARY OF THE INVENTION

Accordingly, in the view of the foregoing, the present inventor makes a detailed study of related art to evaluate and consider, and uses years of accumulated experience in this field, and through several experiments, to create a new access and data management method using double parallel tracks and thereby saving the time and also increasing the working life of the flash memory device.

In accordance with the above object and other advantages of the present invention, an access and data management method using double parallel tracks, in which a plurality of independent USB data is simultaneously transferred from a plurality of flash memory cells. When the flash memory is enabled for reading or writing multiple sectors, the controller will take a plurality of pages as a unit to implement reading or writing. By using the double parallel track structure in conjunction with interleaving method including at least one flash memory cell to cooperate with the controller, such schemes can substantially extend the use of the flash memory and additionally upgrade the writing speed of the flash memory, thus the process of using the flash memory cell is correspondingly smoother and enable the controller to transport more data simultaneously. A mother and child concept is applied to process the data of a flash memory cell. The so-called mother and child are two physical features owning a logical address at the same time to allow the host to write to a logical address. The controller defines the physical block that corresponds to the logical block as the mother block, then unify the mother block with the corresponding logical block wherein the back up logical zone, if the host is going to write to page N, the controller will move from block 0 to block N-1 from the mother block to the child block; then begins to write from block N of the child block. After finishing processing the data, the controller will not immediately move the rest of blocks from the mother block to the child block, instead waits until the host begins to write for the next time and judges whether to continue writing from the same address, if yes, then there is no need for the controller to find a new block, instead directly writes into the very block, after finishing writing all the pages of the child block, the controller will erase the mother block, and then replaces the mother block completely by the child block. Thus the controller need not repeat the transferring and erasing actions while writing data to the flash memory cell, accordingly the life of the flash memory can be extended and the processing speed can be substantially upgraded. Additionally, the time of waiting status of the flash memory cell can be shortened by the Copy Back command. When using the Copy Back command, the flash memory will not process reading data, instead merely puts the data into the internal buffer of the flash memory, and further, the flash memory cell will write the data stored temporarily in the internal buffer into the flash memory by Copy Back command, therefore, the time spent as above is substantially shorter than reading out then writing into the flash memory cell.

According to another aspect of the present invention, the access and data management method as describe above can be combined with an interleaving method to manage the flash memory cell, and also can be suitably applied in any hosting device, comprising a portable ROM, a card reader in USB 1.1 series, or a portable ROM, a card reader in USB2.0 series, or an IDE/PCMCIA interface.

According to another aspect of the present invention, a plurality of flash memory cells are managed using the double tracks, interleaving method and copy back method together to promote the access and data processing speed of the flash memory cells and thereby shorten the time for transferring the data, and also to further extend the life of the flash memory cell.

### BRIEF DESCRIPTION OF THE DRAWING

The invention can be more fully understood by reading the following detailed description of the preferred embodiments, with reference made to the accompanying drawings, wherein:

FIG. 1A is a process flowchart (1) of a conventional method for writing two sets of data into page 3 of the block 0;

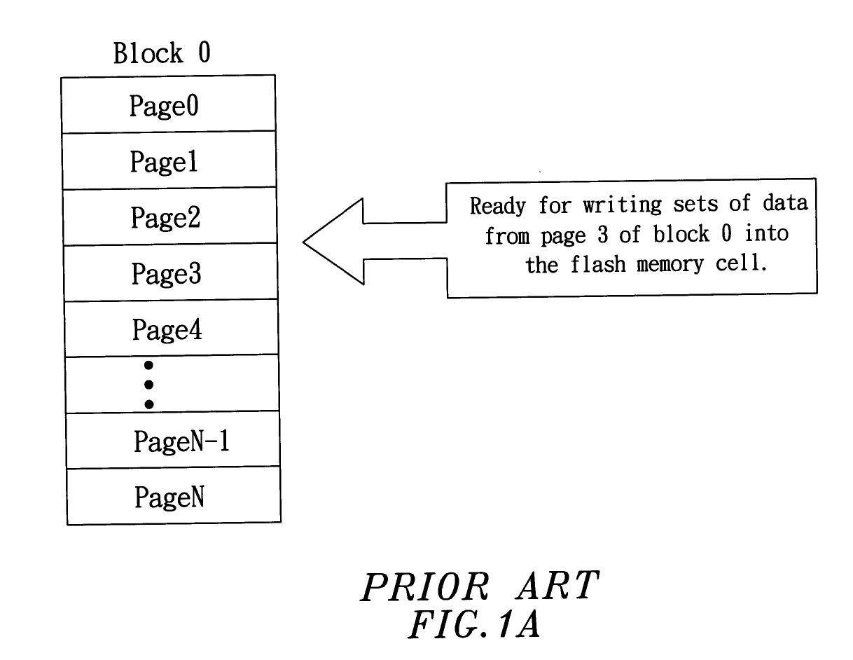

FIG. 1B is a process flowchart (2) of the conventional method for writing two sets of data into page 3 of the block 0;

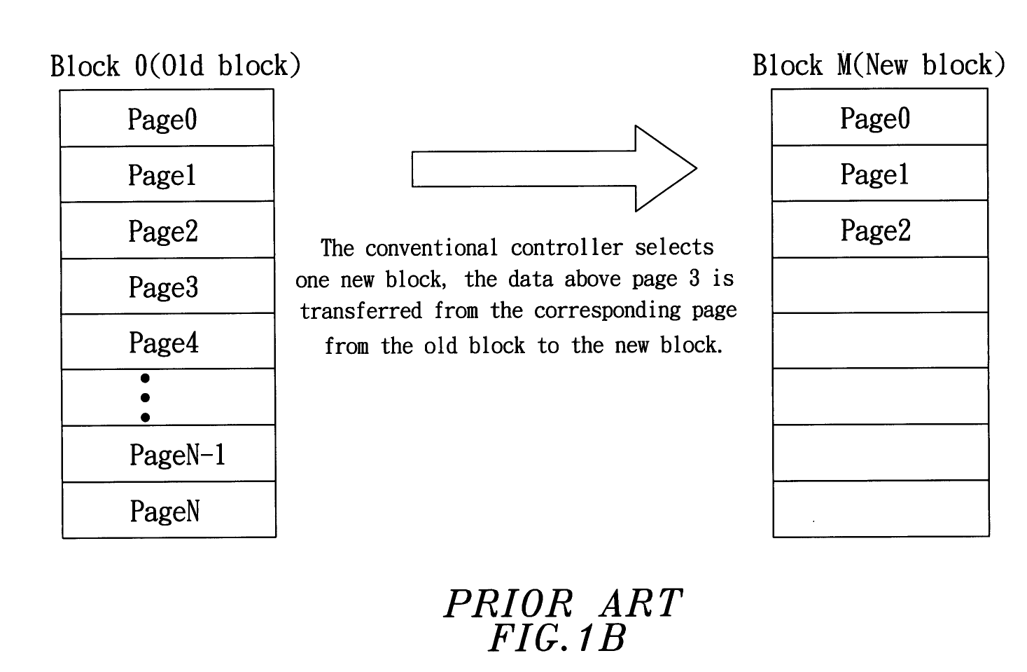

FIG. 1C is a process flowchart (3) of the conventional method for writing two sets of data into page 3 of the block 0;

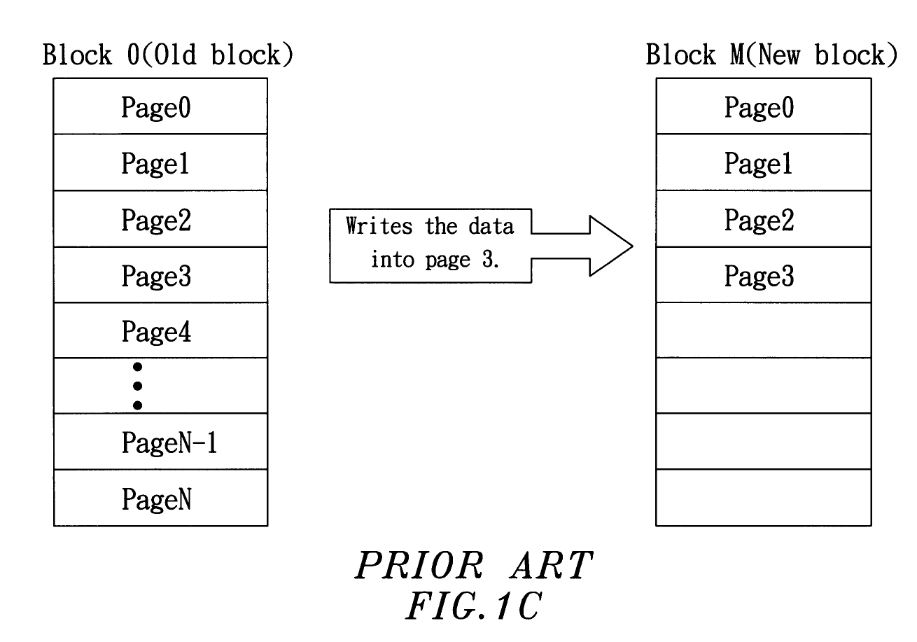

FIG. 1D is a process flowchart (4) of the conventional method for writing two sets of data into page 3 of the block 0;

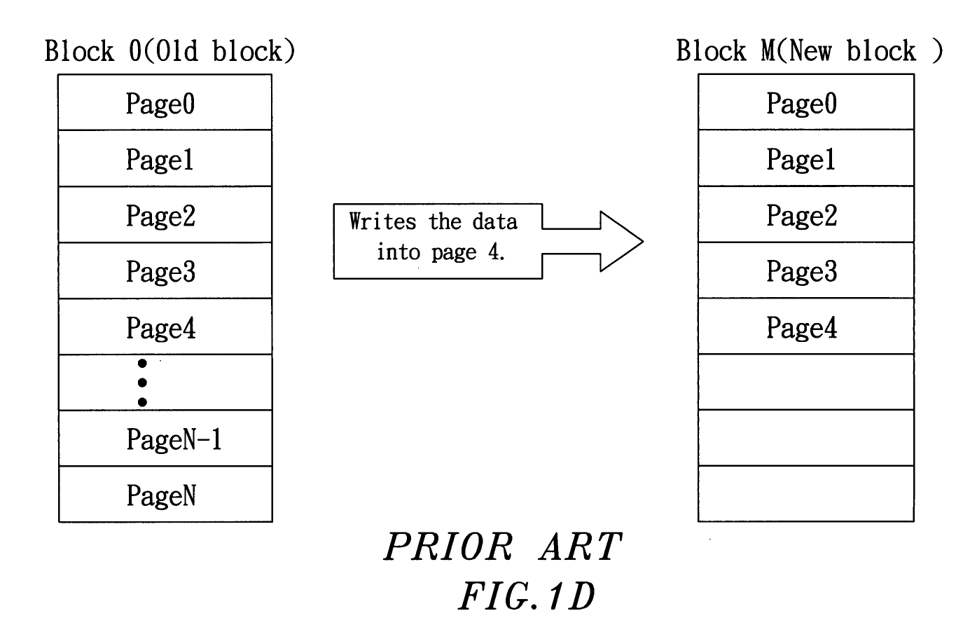

FIG. 1E is a process flowchart (5) of the conventional method for writing two sets of data into page 3 of the block 0;

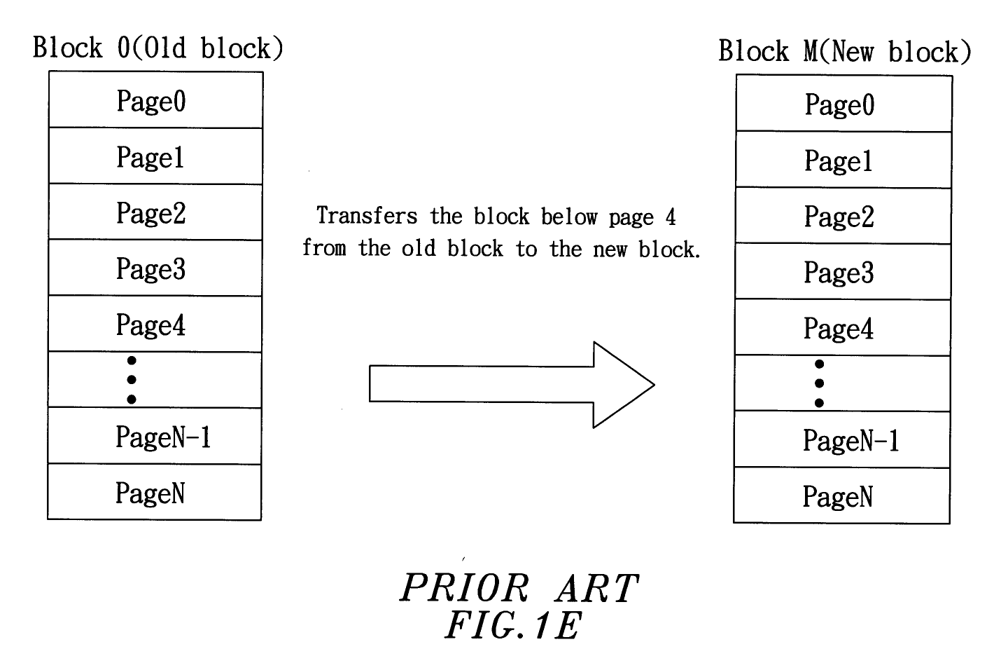

FIG. 1F is a process flowchart (6) of the conventional method for writing two sets of data into page 3 of the block 0;

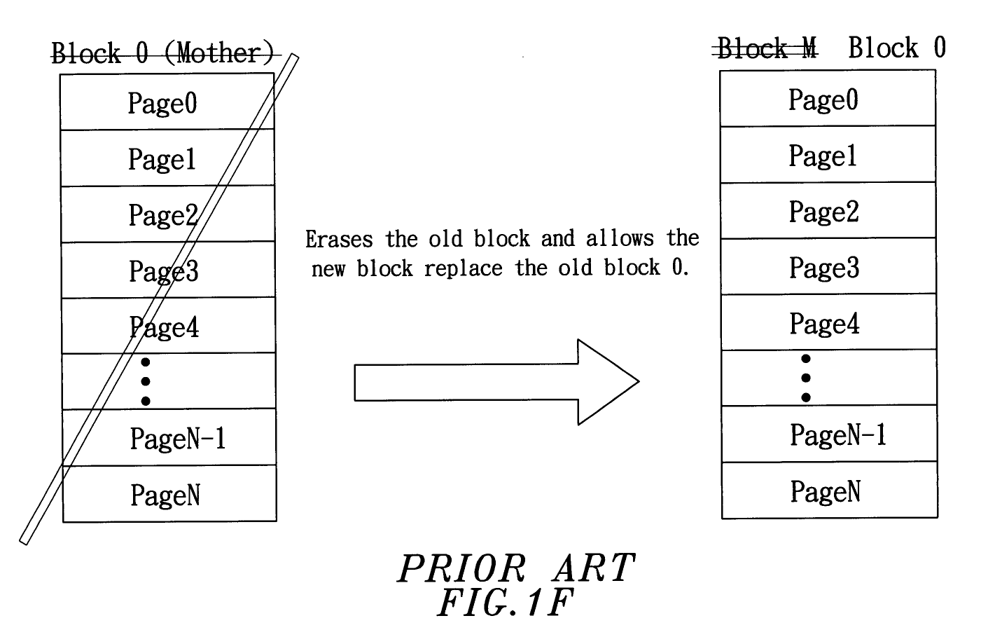

FIG. 2A is a process flowchart (1) of a mother and child conceptual structure for writing two sets of data into page 3 of the block 0;

FIG. 2B is a process flowchart (2) of the mother and child conceptual structure for writing two sets of data into page 3 of the block 0;

FIG. 2C is a process flowchart (3) of the mother and child conceptual structure for writing two sets of data into page 3 of the block 0;

FIG. 2D is a process flowchart (4) of the mother and child conceptual structure for writing two sets of data into page 3 of the block 0;

FIG. 2E is a process flowchart (5) of the mother and child conceptual structure for writing two sets of data into page 3 of the block 0;

FIG. 2F is a process flowchart (6) of the mother and child conceptual structure for writing two sets of data into page 3 of the block 0;

FIG. 2G is a process flowchart (7) of the mother and child conceptual structure for writing two sets of data into page 3 of the block 0;

FIG. 3 is a process flowchart of the interleaving management method using two flash memory cells;

FIG. 4A is a process flowchart of an access and data management method using double parallel tracks for reading data from two flash memory cells according to one preferred embodiment of the present invention;

FIG. 4B is a process flowchart of an access and data management method using double parallel tracks for writing data into two flash memory cells according to one preferred embodiment of the present invention;

FIG. 5A is an arrangement of the flash memory cells while using interleaving management method to manage I_page of I_block;

FIG. 5B is an arrangement of the flash memory cells while using interleaving management method to manage I_block of I_zone;

FIG. 6A is an address distribution chart (1) showing the physical address with the copy back command;

FIG. 6B is an address distribution chart (2) showing the physical address with the copy back command;

FIG. 7 is a procedure of a host reading data from the flash memory cell; and

FIG. 8 is a procedure of a host writing data into the flash memory cell.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

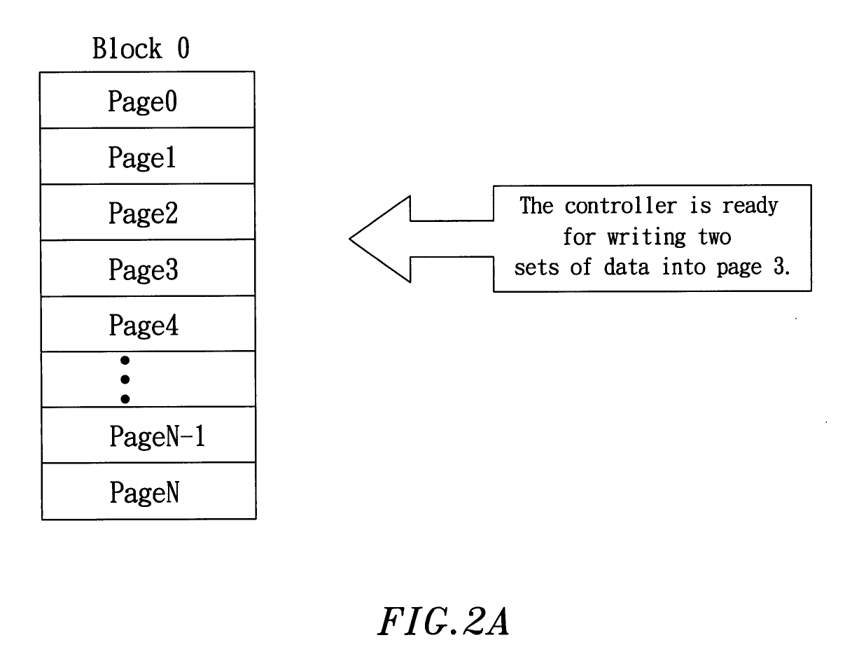

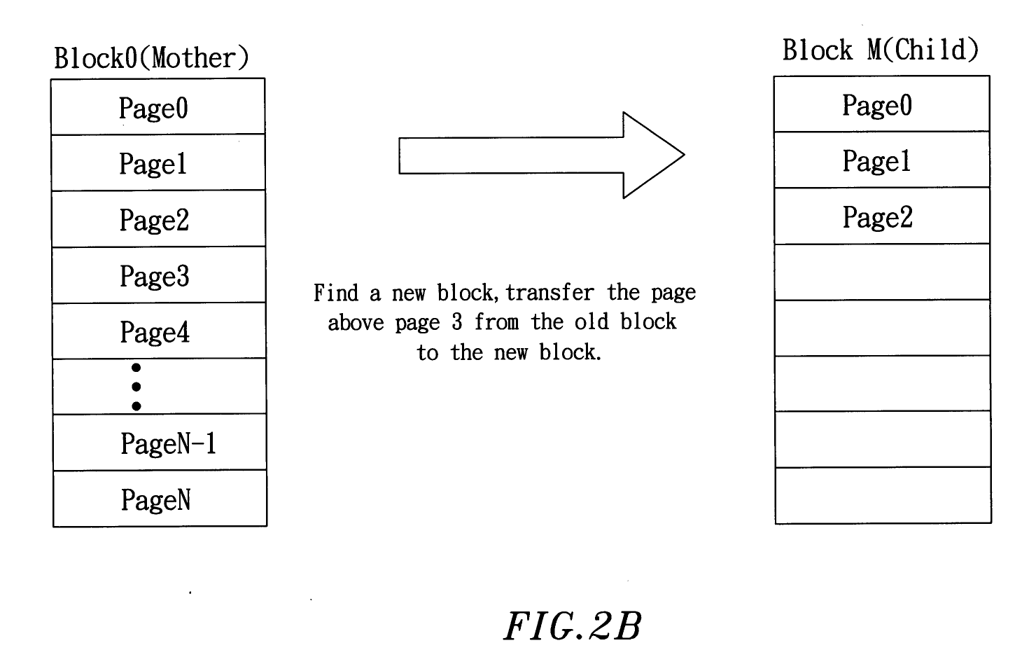

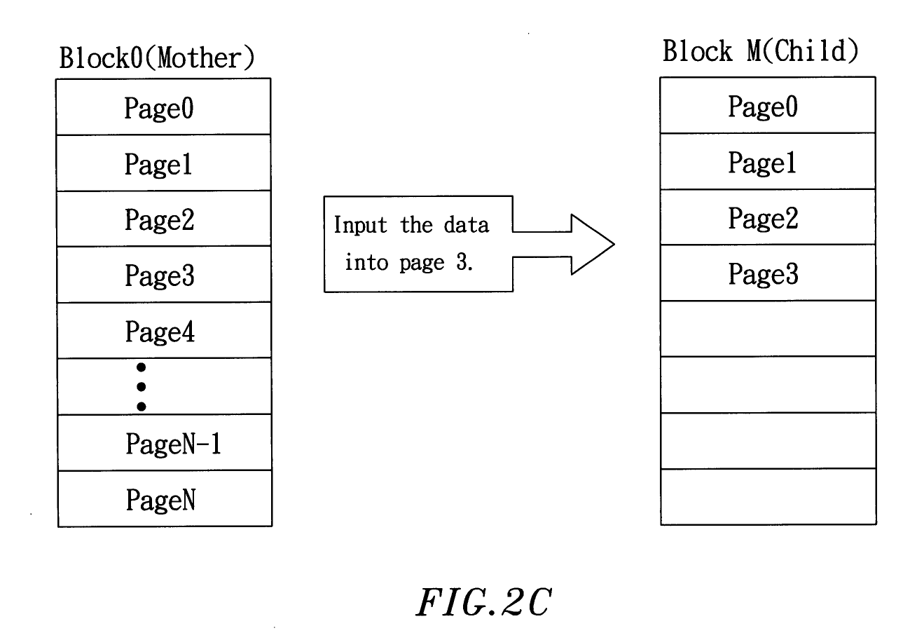

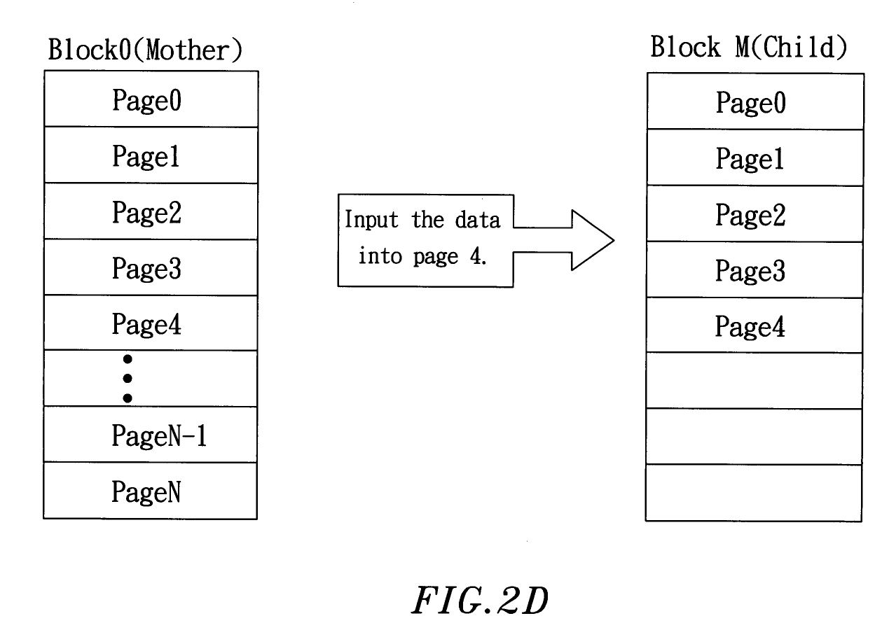

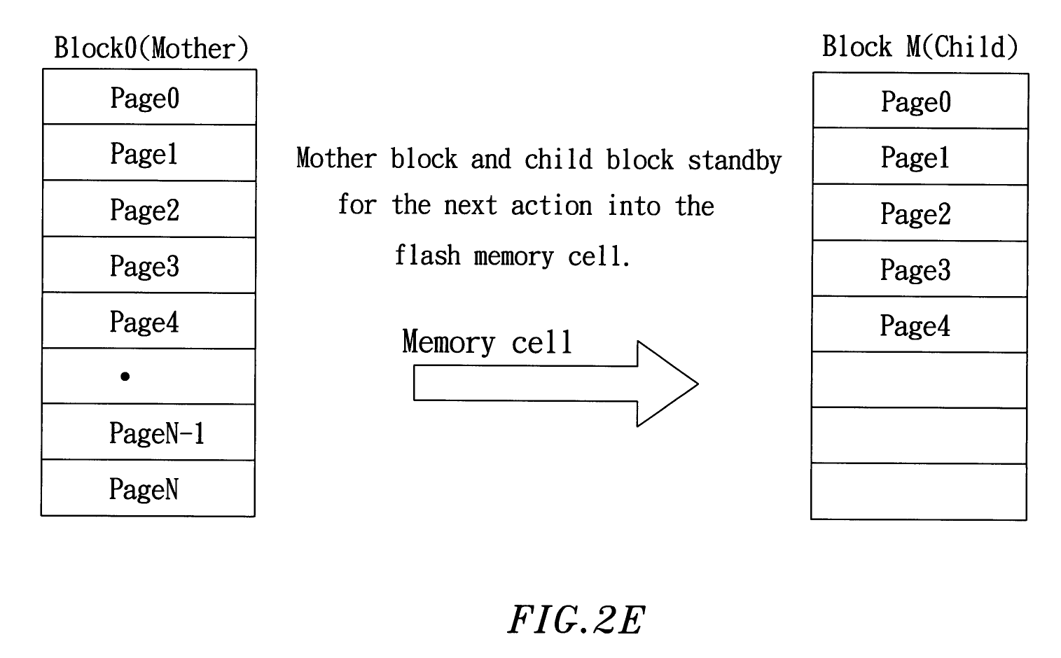

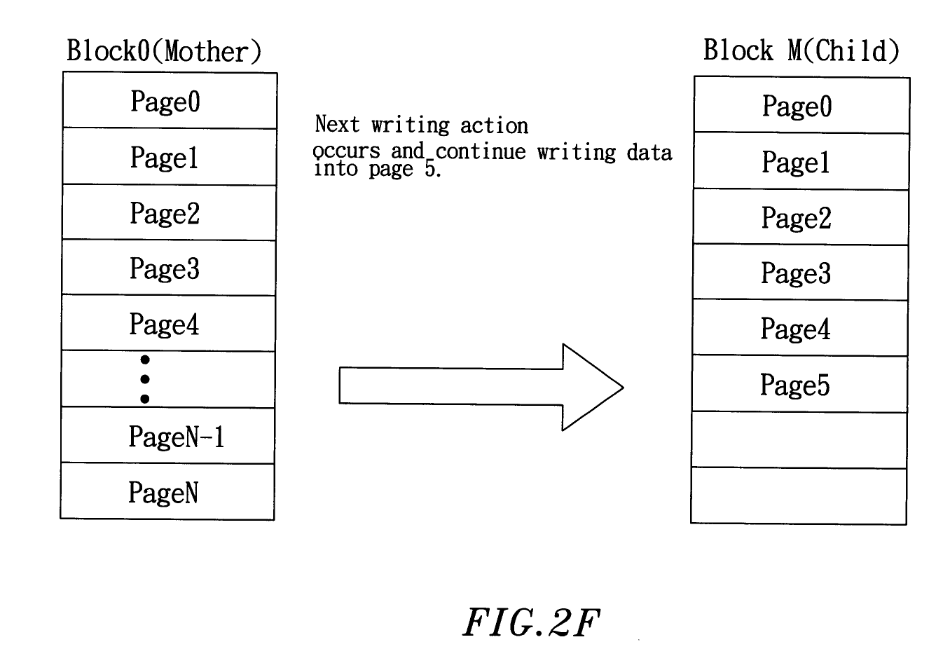

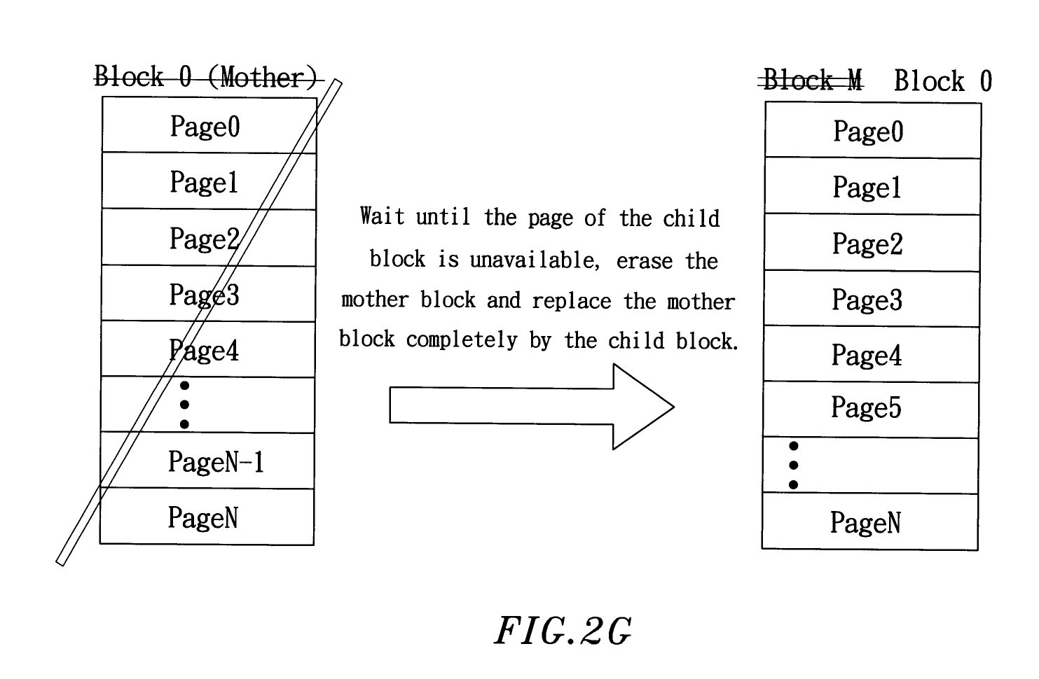

Referring to FIG. 2A, show the process flowchart (1) illustrating the mother and child conceptual structure for writing two sets of data into page 3 of the block 0. The controller is ready for writing two sets of data into page 3 of the block 0. FIG. 2B shows the process flowchart (2) including the mother and child conceptual structure for writing two sets of data into page 3 of the block 0, wherein the controller firstly transfers the data existed in the target block into which the new data is to be written, from the mother block to the child block. FIG. 2C shows the controller transfers the data into page 3, which is to be written as the first set of data into the page of the child block. Further referring to FIG. 2D, the controller transfers the second set of data into page 4 of the child block. And as shown in FIG. 2E, that the controller does not transfer the rest of the blocks of the mother block to the child block immediately, instead continues writing data into the next block in the child block then standby for the next action into the flash memory cell. Now referring to FIG. 2F, when the next writing action occurs, the controller writes the new first set of data to the next block, block 5, of the child block. And finally, referring to FIG. 2G, the mother block is erased and replaced completely by the child block when all the blocks of the child block are unavailable.

Taking two 64 MB flash memory cells as an example for illustrating the interleaving structure, there are 32 pages in a zone, and will be 64 pages in a zone while executing the interleaving structure. Wherein, the first page is the original first page of the first flash memory cell, the second page is the original first page of the second flash memory cell, the third page is the original first page of the first flash memory cell, the first page is the original second page of the first flash memory cell and the fourth page is the original second page of the second flash memory cell. In other words, the even number of the pages in a block is distributed to the first memory cell, and the odd number of the pages in a block is distributed to the second memory cell.

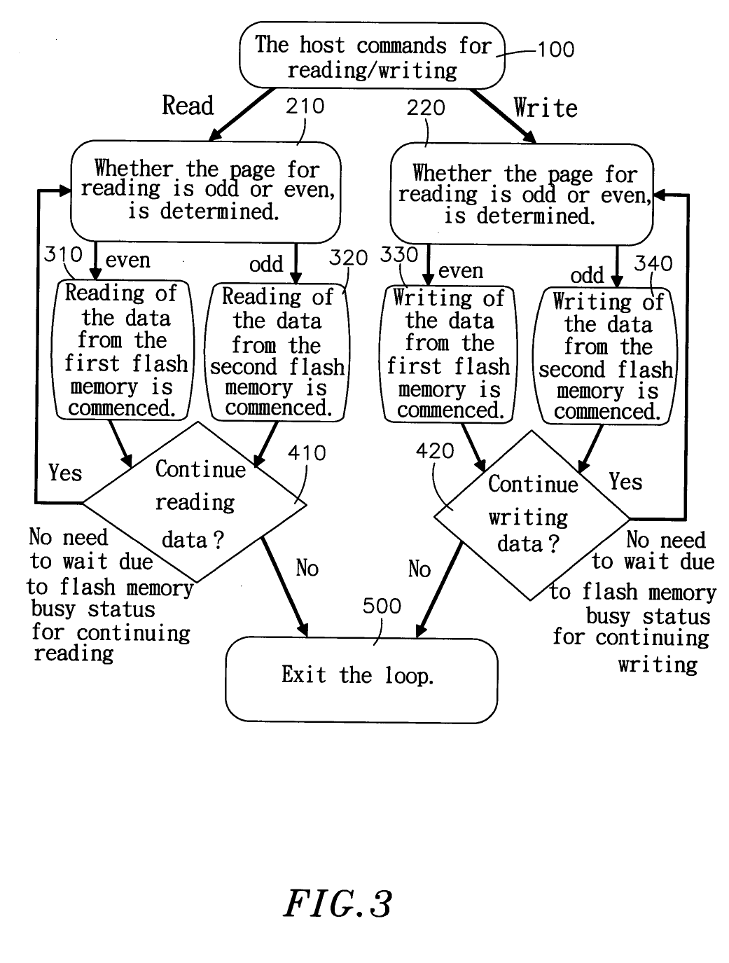

Referring to FIG. 3, the process flowchart of a interleaving method using two flash memory cells, wherein, taking writing in as an example, when writing two or more sectors into the flash memory cell, the first memory cell 330 will be in the busy condition when writing the first sector therein, there is no need for the program to wait until the writing of first sector is complete, in other words, during the writing of the first sector, the second flash memory cell 340 is enabled so as to write the second data therein. If there is a third set of data to be written into the first flash memory 330, then the process steps are repeated as described above. Accordingly, there is no need of waiting for completion of writing of the second set of data into the second memory cell 340, in other words, during the writing of the second sector into the second flash memory cell 340, the first flash memory cell 330 is enabled so as to write the third set of data therein. Therefore, the time for writing data as described above can be substantially reduced. The detailed writing process can be described as follows.

In step (100), the host issues reading/writing signal. Step (210), is the reading step.

Step (220), is the writing step.

In step (210), whether the target page for reading is odd or even is determined. If the page is odd, then the process proceeds to step (340). If the page is even, then the process proceeds to step (330).

In step (220), whether the target page for writing is odd or even is determined. If the page is odd, then the process proceeds to step (320). If the page is even, then the process proceeds to step (310).

In step (310), reading data from the first flash memory cell 330 is commenced, then the process proceeds to step (410).

In step (320), reading data from the second flash memory cell 340 is commenced, then the process proceeds to step (410).

In step (330), writing data into the first flash memory cell 330 is commenced, then the process proceeds to step (420).

In step (340), writing data into the second flash memory cell 340 is commenced, then the process proceeds to step (420).

In step (410), whether to continue reading data is determined. If yes, then the process returns to step (210), if not, the process skips to (500).

In step (420), whether to continue writing data is determined. If yes, the process returns to step (220), if not, the process skips to (500).

In step (500), the process ends and exits the loop.

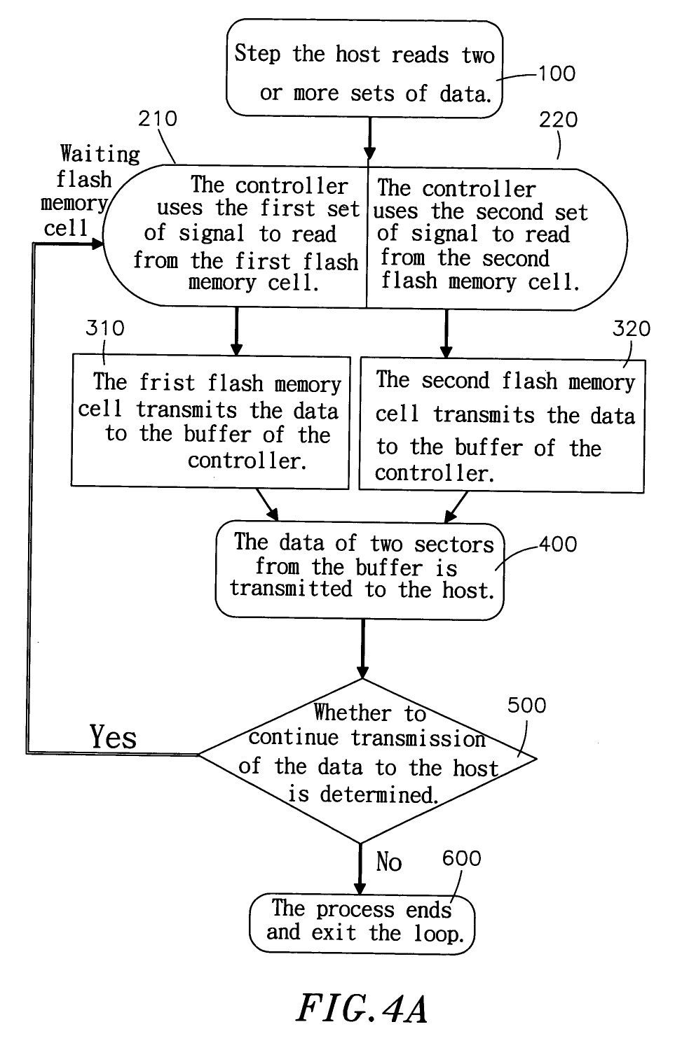

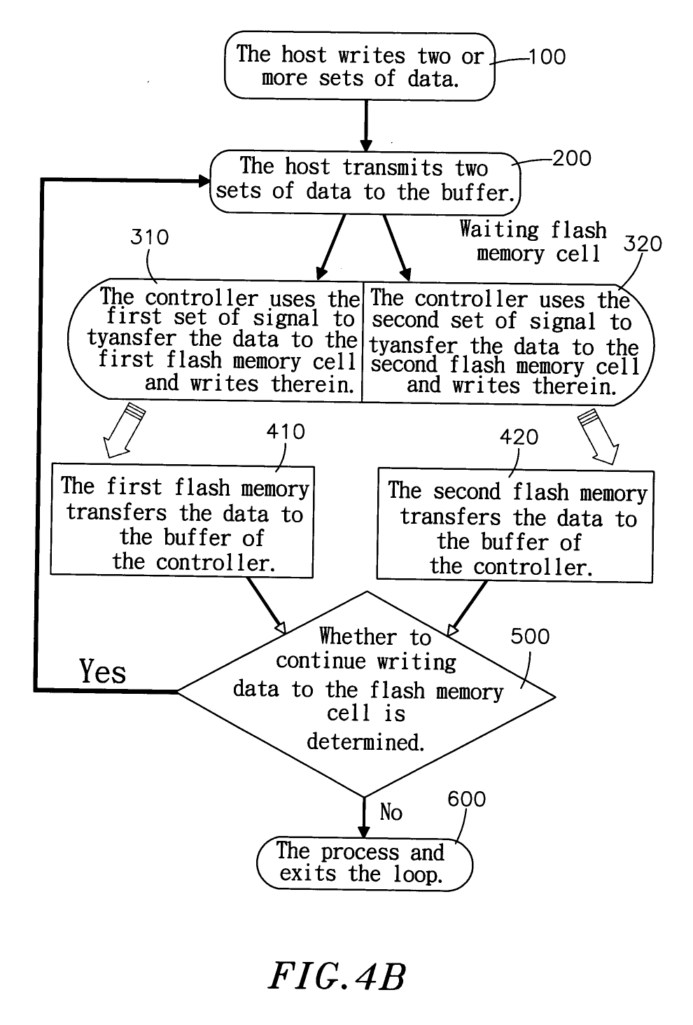

Referring to FIG. 4A, the process flowchart of the access method using double parallel tracks of the present invention is described. To read from the two flash memory cells, the controller takes two pages at a time to begin the reading/writing process into two different flash memory cells simultaneously. In this situation, the hardware requires two sets of independent USB ports for two flash memory cells, and these two USB ports connect to the flash memory cells separately. The controller transfers the data through these two USB ports to the two flash memory cells simultaneously. The controller issues read signal to the first flash memory cell and the second flash memory cell for reading therein through these two independent USB ports. The reading process is described as follows.

Step (100) the host reads two or more than two sets of data, then the process proceeds to step (210) and step (220).

In step (210), the controller uses the first set of signal to read data from the first flash memory cell, then the process proceeds to step (310).

In step (220), the controller uses the second set of signal to read data from the second flash memory cell, then the process proceeds to step (320).

In step (310), the first flash memory cell transmits the data to the buffer of the controller, and the process proceeds to step (400).

In step (320), the second flash memory transmits the data to the buffer of the controller, and the process proceeds to step (400).

In step (320), the second flash memory transmits the data to the buffer of the controller, and the process proceeds to step (400).

In step (400), the data of two sectors from the buffer is transmitted to the host, then the process proceeds to step (500).

In step (500), whether to continue transmission of the data to the host is determined, if yes, then the process proceeds to step (220), if not then, the process proceeds to step (600).

In step (600), the process ends and exits the loop.

Furthermore, referring to FIG. 4B, the process flowchart the access method using double parallel tracks of the present invention is described. To write into the two flash memory cells, the controller takes two pages at a time to begin the writing process into two different flash memory cells at the same time. The controller issues write signal to the first flash memory cell and the second flash memory cell for writing therein through these two independent USB ports. The writing process is described as follows.

In step (100), the host writes two or more sets of data, then the process proceeds to step (200).

In step (200), the host transmits two sets of data to the buffer, then the process proceeds to steps (310) and (320);

In step (310), the controller uses the first set of signal to transfer the data to the first flash memory cell and writes therein, and then the process proceeds to step (410).

In step (320), the controller uses the second set of signal to transfer the data to the second flash memory and writes therein, and then the process proceeds to step (420).

In step (420), the second flash memory transfers the data to the buffer of the controller, and then the process proceeds to step (500).

In step (500), whether to continue writing data to the flash memory cell is determined, if yes, then the process proceeds to step (200), if not, then the process proceeds to step (600).

In step (600), the process ends and exits the loop.

For the clearer description, the physical location of the flash memory cell is defined by zone, block and page; and the physical location of the interleaving management is defined by I_zone, I_block and I_page. There are four zones in a 64 mb flash memory cell, 1024 blocks in each zone, and 32 pages in each block. In the file management procedure of the flash memory cell, because the data stored in the flash memory needs to be transferred constantly, the controller has to read and write the data into the flash memory all the time. And it will make the controller stay in the busy condition for a long time. For upgrading the speed, the new generation of the flash memory cell has a new copy back command. When the flash memory receives the copy back read command, the flash memory does not read out the data, but instead, the flash memory cell puts the data into an internal buffer. Then, when the flash memory cell receives the copy back write command signal, the flash memory cell will write the data stored temporary in the internal buffer into the flash memory cell. The time spent for finishing the above procedure is substantially less compared to reading out then writing the data. The flash memory recognized copy back command is divided into four planes, and therefore only the flash memory cell has a capacity of 64 (10⁶) mb or more supports and therefore only the flash memory cell has a capacity of 64 (10⁶) mb or more supports copy back command. An example of using two 64 mb flash memory cells is described below.

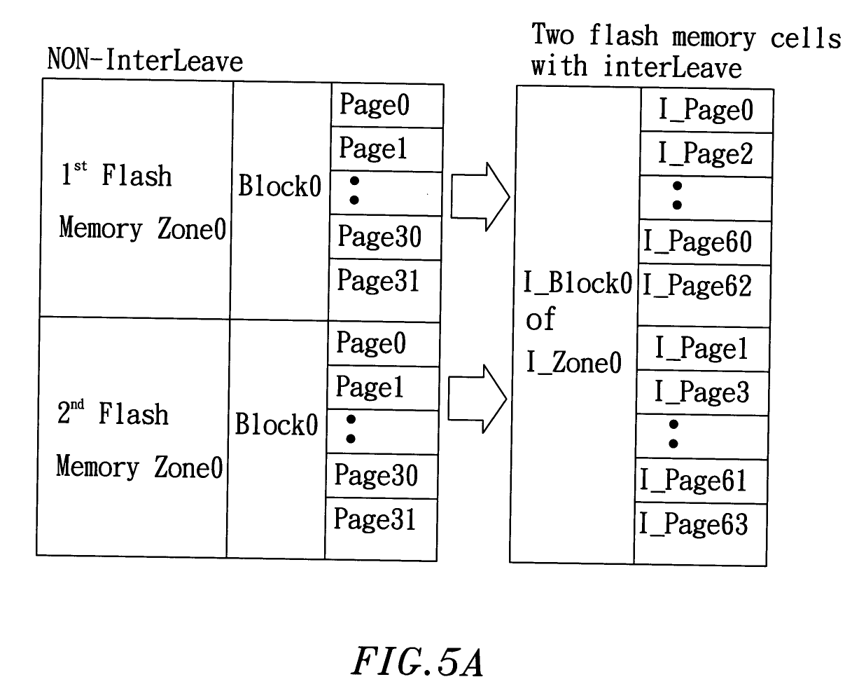

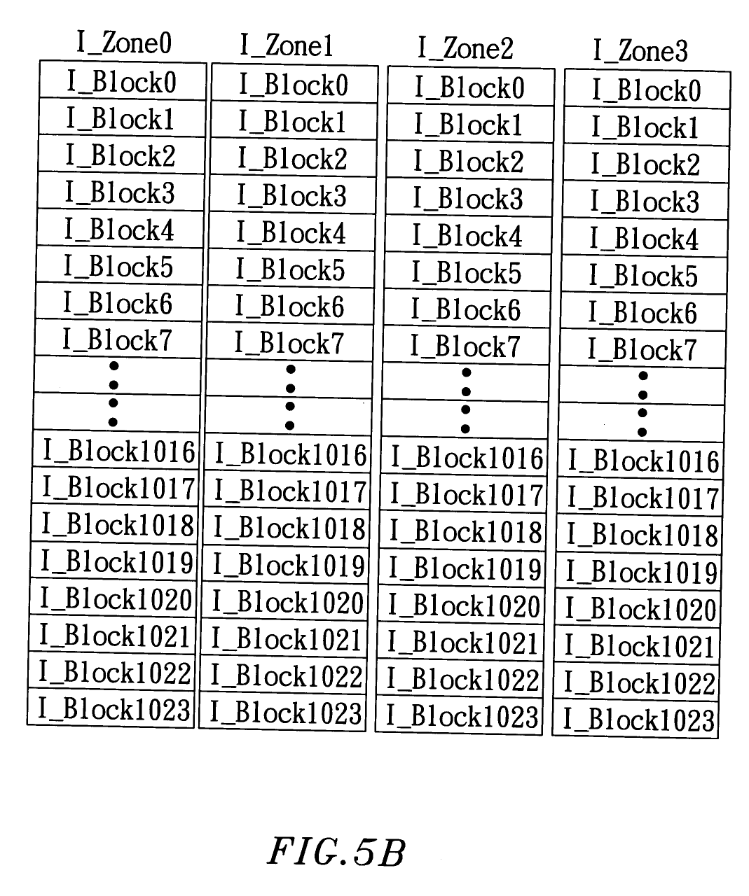

Referring to FIG. 5A, shows the arrangement of the flash memory cells while using interleaving method to manage I_page of I_block, I_zone 0 in each flash memory cell belonging to zone 0, and I_zone 1 in each flash memory belonging zone 1. Accordingly divide into four large blocks as I_zone 0, I_zone 1, I_zone 2 and I_zone 3, wherein I_zone still contains 1024 I_blocks and each I_block belonging to the same block of the two flash memory cells. Therefore, each I_page of I_block is twice of a block in other words, an I_block contains 64 I_pages, and the interleaving structure consist two 64 mb flash memory cells comprising four I_zones, each I_zone comprises 1024 I_blocks, and each I_block has 64 I_pages.

The total capacity of the above arrangement is 2*1024*128*512 bytes, and it is equal to 64*2 mb. The distribution of I_page is arranged in terms by the pages of the two blocks within I_block, using I_block 0 of I_zone 0 as an example, I_Page 0 of I_block 0 in the physical address is distributed to page 0 of block 0 of zone 0 in the first flash memory, and I_page 1 is distributed to page 0 of block 0 of zone 0 in the second flash memory; and I_page 2 is distributed again to page 1 of block 0 of zone 0 in the first flash memory, then I_page 3 is distributed to page 1 of block 0 of zone 0 in the second flash memory, and the rest is distributed accordingly.

Referring to FIG. 5B, shows the arrangement of the flash memory cells while using interleaving method to manage I_block of I_zone; the physical address arrangement will be the final physical address in the case of without using copy back command in the file management, but with the copy back command in the file management, modification will be required for upwards.

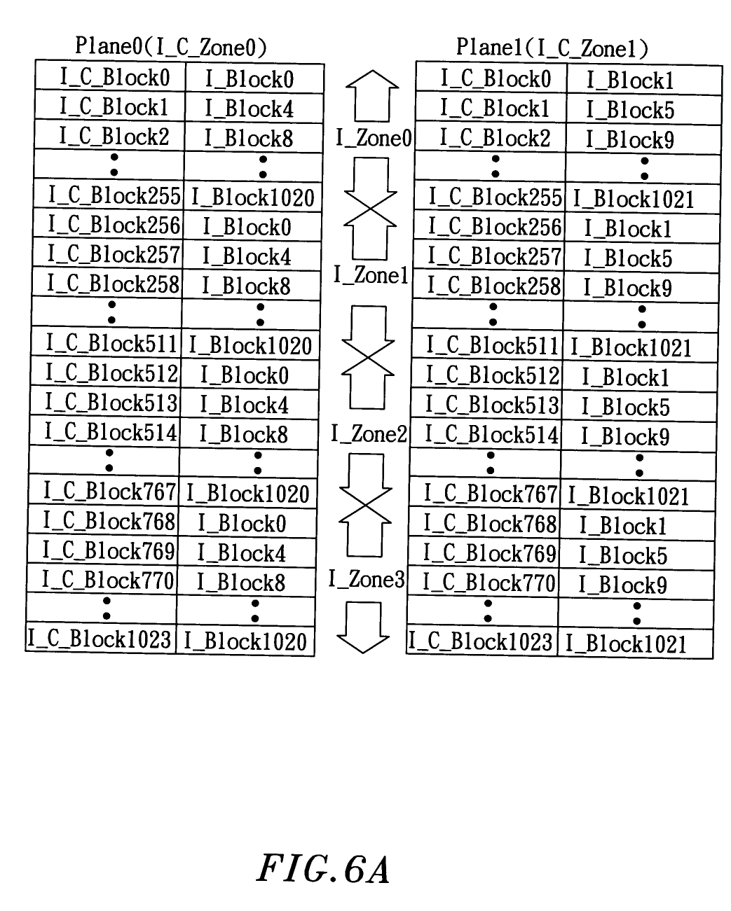

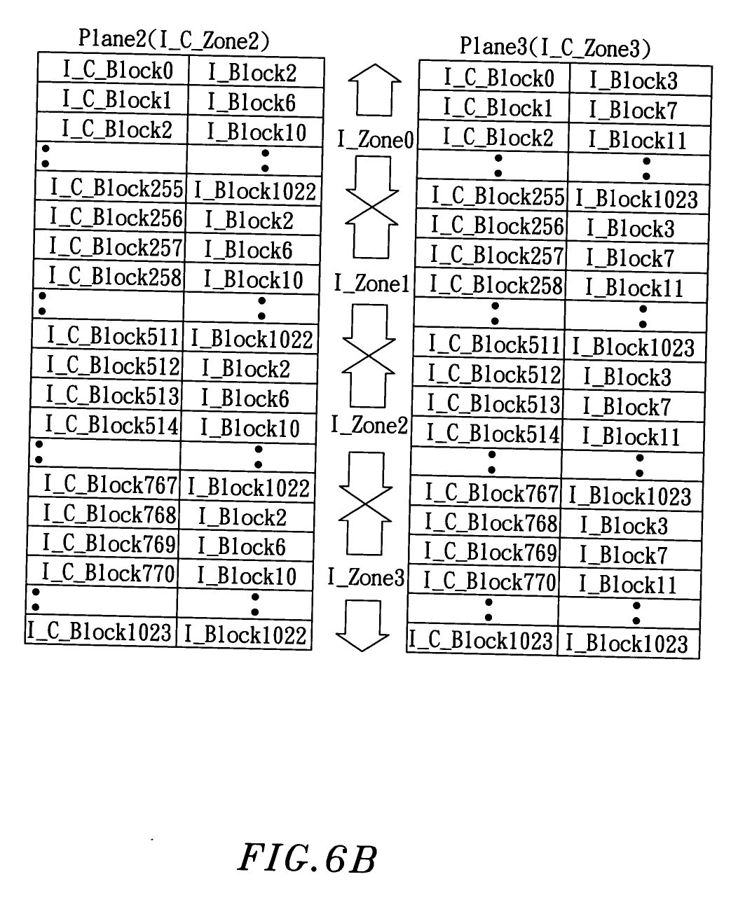

Furthermore, referring to FIGS. 6A and 6B, are the address distribution charts 1 and 2 showing the physical address using the interleaving method of the present invention. The embodiment of the present invention interleaves flash memory cells with the new copy back command. The management with the new copy back divides the flash memory into four planes, only I_C_block in the same plane is able to accept copy back command, I_C_block of plane 0 includes all the 4n+0 (0≦n≦255) I_block of I_zone, I_C_block of plane 1 includes all the 4n+1 (0≦n≦255) I_block of I_zone; I_C_block of plane 2 includes all the 4n+2 (0≦n≦255) I_block of I_zone; I_C_block of plane 3 includes all the 4n+3 (0≦n ≦255) I_block of I_zone; and plane 0 can be taken as a new I_C_zone 0 and plane I can be taken as a new I_C_zone 1, and so on. Thus the physical address in this file management is different from the actual address of the flash memory. However, with interleaving and copy back management, the physical address mentioned hereinafter is substantially different from the flash memory. Before using the flash memory, it is must to find the logical address corresponding to the physical address of the flash memory. The correspondent of the logical and physical position is called link table.

And because this management structure is based the mother and child concept, there is a possibility that two physical positions in a flash memory correspond to the same logical position. In this situation, the controller has to judge which one of these two physical positions belongs to the mother and which one of these two physical positions belongs to the child, and then combine the mother and child together, fill up the rest of pages of the child by the pages of the mother then erase the mother. Thus the logical and physical positions in the link table are corresponding to each other one after another. When the link table is set and the host requests a logical position to the flash memory, the controller can locate the corresponding physical position in the flash memory promptly and process. The initialization is not only for building up a link table, but also for marking those blocks that has no logic or being processed inappropriately for back up blocks.

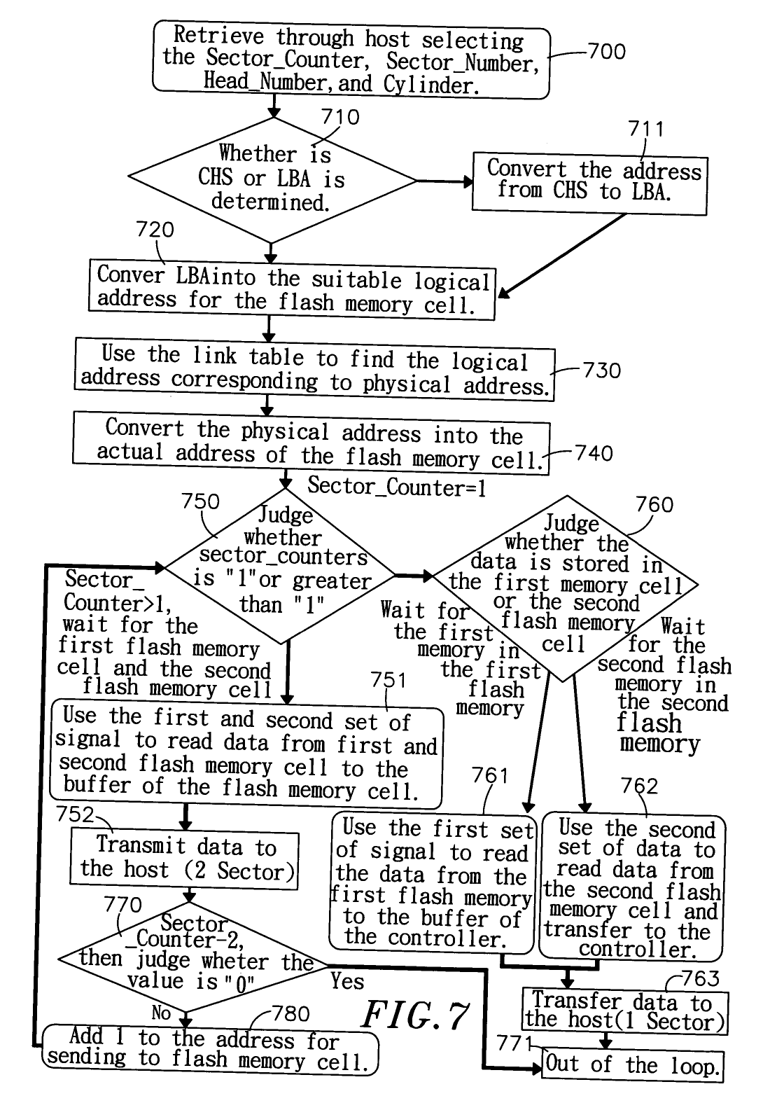

Referring to FIG. 7 is a process flowchart illustrating a host reading data from a flash memory.

Step 1, retrieve the sixth bit Head_Number (Byte) from the host and mark it as address in the host (700), whether is CHS or LBA (710) is determined, wherein 0 is for CHS and 1 is for LBA, if it is determined to be LBA, then the process proceeds to step (720) for LBA, or to step (711) if it is determined to be CHS.

The manner of converting LBA and CHS is described as below:
LBA=(((Track*Head_per_Track)+Head_Num)*Sector_per_Head)+Sector_Num)−1
Remarks: a. the parameters of the above formula is in CHS;
b. track: which cylinder;
c. Head_per_Track: how many heads is a track;
d. Head_Num: which head;
e. Sector_per_Head: how many sectors in a head
f. Sector_Num: which sectors;
g. the result in LBA converted by the formula indicates which sector the very address is; and
h. sector counter: how many sets of data have to transmit to the host.

Step 2, calculates the address that the LBA is pointing at, by checking how many zones does the flash memory has, and how many blocks in a zone, how many pages in a block (a page is equal to a sector) (720), and the resulting address is the so-called logical address, then checking which page of which block and in which zone this logical address is located to match with link table for finding the corresponding physical address (730);

Step 3, the actual address of the flash memory corresponding to the physical address (740) can be found by using the converting method shown in FIGS. 5A, 5B and 6.

Step 4, although two pages are used as a unit in the controller for reading data, however the number of sets of data that the host required may not be always even, therefore, it is necessary to judge whether the data for reading is one set or more (750), if there is more than one set of data, the controller will take two pages as a unit for reading data, then the process proceeds to step (751), on the other hand, if there is only one set of data (750), then the controller will take one page as a unit for reading data from the flash memory cell, then the process proceeds to step (760).

Step 5, the controller judges whether the set of data is stored in the first flash memory cell or the second memory cell (760), if the set of data is stored in the first flash memory cell, then the controller uses the first set of signal to read data from the first flash memory cell and transmits the data to the buffer of the controller (761), on the other hand, if the set of data is stored in the second flash memory cell, then the controller uses the second set of signal to read data from the second flash memory cell and transmits the data to the buffer of the controller (762), then transmits the data from the buffer to the host (763), and leaves the loop (771).

Step 6, the controller takes two pages as a unit to read data (750), the controller uses the first and second set of signals to read data from both the first flash memory cell and the second flash memory cell (751) (the difference of the address bus of the first and second set of signal is 1 for this command), and puts the data in a orderly manner into the buffer of the controller then also in transmits in orderly manner to the host (752). The data of the first flash memory cell may not be the first one to be transmitted, because the host may start from the second flash memory cell, therefore, the controller has to judge sequence by the initial address of the host.

Step 7, after the address is increased, whether any more sets of data has to be read from the flash memory cell (780) is determined, if there are more data to be read, then returns to step (750).

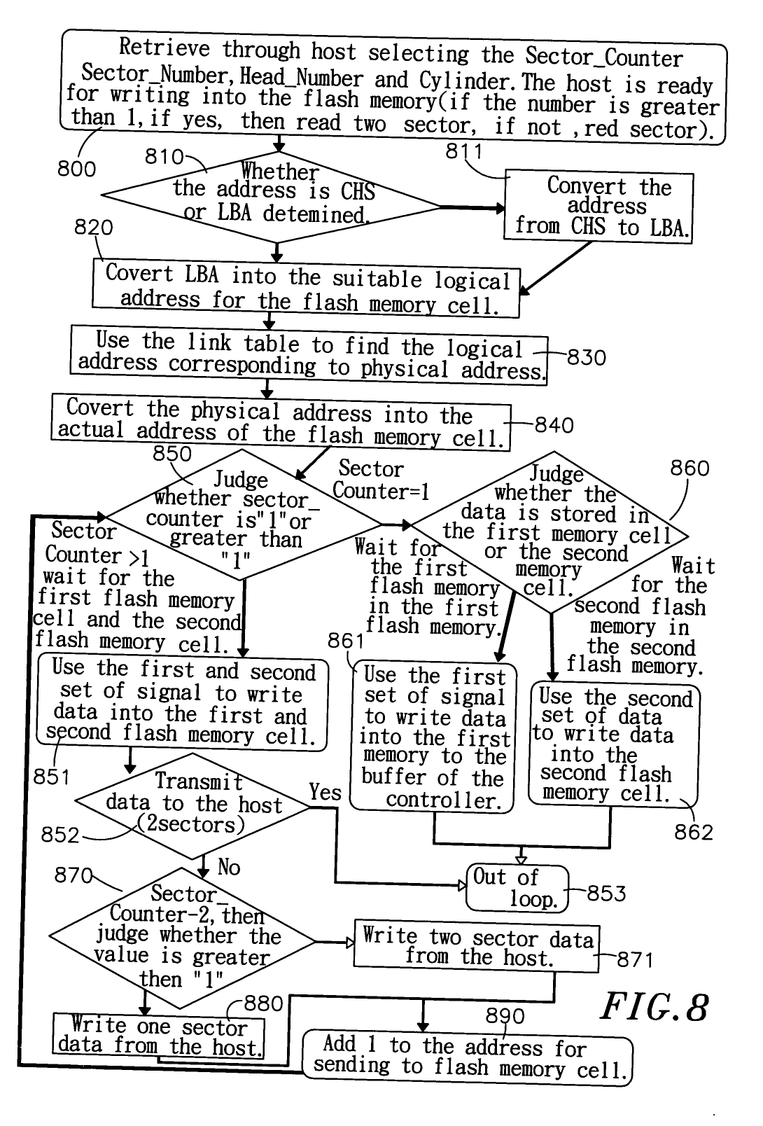

Referring to FIG. 8, is a process flowchart illustrating a host reading data from a flash memory cell.

Step 1, the host marks the sixth bit of the Head_Number (byte) as the selected position (800), whether is CHS or LBA (810) is determined, wherein 0 is for CHS and 1 is for LBA, if it is determined to be LBA, then the process proceeds to step (820) for LBA, or to step (811) if it is determined to be CHS.

The manner of converting LBA and CHS is described as below:
LBA=(((Track*Head_per_Track)+Head_Num)*Sector_per_Head)+Sector_Num)−1
Remarks: a. the parameters of the above formula is in CHS;
b. track: which cylinder;
c. Head_per_Track: how many heads is a track;
d. Head_Num: which head;
e. Sector_per_Head: how many sectors in a head
f. Sector_Num: which sectors;
g. the result in LBA converted by the formula indicates which sector the very address is; and
h. sector counter: how many sets of data have to transmit to the host.

Step 2, calculates the address that the LBA is pointing at, by checking how many zones the flash memory has, and how many blocks in a zone, how many pages in a block (a page is equal to a sector) (820), and the resulting address is the so-called logical address, then checking which page of which block and in which zone this logical address is located to match with link table for finding the corresponding physical address (830).

Step 3, the actual address of the flash memory corresponding to the physical address (840) can be found by using the converting method shown in FIGS. 4, 5A, 5B, 6A and 6B.

Step 4, although two pages are used as a unit for reading data, the number of the sets of data required by the host may not be always even, therefore, it is necessary to judge whether the data for further writing is one set or more than one set of data (850), if there are more than one sets of data, then the controller will take two pages as a unit for writing data, then proceeds to step (851), if there is only one set of data (850), then the controller will take one page as a unit for writing data from the flash memory cell, then the process proceeds to step (860).

Step 5, the controller judges whether the set of data is stored in the first flash memory cell or the second flash memory cell (860), if the set of data is stored in the first flash memory cell then the controller uses the first set of signal to write data into the first flash memory cell and transmits the data from the buffer of the controller (861), on the other hand, if the set of data is stored in the second flash memory cell, then the controller uses the second set of signal to write data into the second flash memory cell and transmits the data from the buffer of the controller (862), then transmits the data from the buffer to the host (863), and then leaves the loop (871).

Step 6, the controller takes two pages as a unit to read data (850), the controller using the first and second set of signals to write data into both the first memory cell and the second flash memory cell (851) (the difference of the address bus of the first and second set of signal is 1 for this command), and transfers the data in an orderly manner from the buffer of the controller to the flash memory cell, from the start, the first data may not be written into the first flash memory cell, because the host may start from the second flash memory cell, therefore, the controller needs to judge the sequence by the initial address of the host (852).

Step 7, use the Sector_Counter to reduce two then judging whether it is 0, then proceeds to step (853), if yes then the process exits the loop, and if not, then the process proceeds to step (870).

Step 8, whether the Sector_Counter is bigger than 1 (870) is determined, if it is not and the data for writing is only one set left, the controller retrieves one set of data from the host (880); if is yes, the controller retrieves two sets of data from the host (871).

Step 9, after the address increases, whether there is any more sets of data to read from the flash memory cell (890) is determined, if it is yes, then the process returns to step (850).

Furthermore, the double tracks and the interleaving method of the present invention can also be suitable applied in any hosting device, such as a portable ROM, a card reader in USB 1.1 series and a portable ROM, a card reader in USB2.0 series or an IDE/PCMCIA interface.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. An access and data management method using parallel tracks comprising a plurality of flash memory cells, a plurality of independent USB ports for transferring sets of data from and within said flash memory cells, wherein when a target set of data is a plurality of sectors, then a controller uses a plurality of pages as a single unit to process reading and writing so that a plurality of pages can be read and written into said flash memory cells simultaneously at each time.

2. The access and data management method according to claim 1, wherein further combining with an interleaving method including two or more flash memory cells.

3. The access method according to claim 2, wherein said interleaving method allows reading/writing a second set of data into the flash memory cells independent of reading/writing of a first set of data into the flash memory cells through the plurality of USB ports and therefore reduces a waiting time for reading/writing, and said flash memory cells can transport data through said plurality of independent data USB.

4. The access and data management method according to claim 2, wherein further combining with a mother and child concept for processing sets of data, so that the controller need not repeat transferring or erasing actions into said flash memory cells while writing said sets of data, and therefore the life of said flash memory cell can be extended, and also an operating speed of writing into said flash memory cell can be increased.

5. The access and data management method according to claim 2, wherein further combining with a copy back command to put data into a buffer temporarily for reducing the chances of waiting and thereby further reducing the time for transferring the sets of data.

6. The access and data management method according to claim 1, wherein the method of using the parallel tracks of flash memory cells can be suitably applied in any host, wherein the host comprising a portable ROM, a card reader in USB 1.1 series or a portable ROM, a card reader in USB2.0 series or an IDE/PCMCIA interface.
